(19) United States
(12) Patent Application Publication
(10) Pub. No.: US 2002/0144762 A1
(43) Pub. Date: Oct. 10, 2002

(54) Vehicle tire having sipes

(76) Inventors: Karl Peda, Wunstorf (DE); Helmut Rodewald, Hohenhamelng (DE)

Correspondence Address: ROBERT W. BECKER & ASSOCIATES, 707 HIGHWAY 66 EAST, SUITE B, TIJERAS, NM, 87059, US

(21) Appl. No.: 09/900,739

(22) Filed: Jul. 6, 2001

(30) Foreign Application Priority Data
Jul. 6, 2000 (DE) 100 32 372.3

(51) Int. Cl. B60C 11/00

(52) U.S. Cl. 152/209.8; 152/209.13; 152/209.15

(57) ABSTRACT

A vehicle tire is provided that includes a tread band formed of profile elements which may be profiled blocks. The profile elements of one group of profile elements are arranged in pitches and are of relatively greater circumferential length than the profile elements in another group of the profile elements. The one group of the profile elements and the other group of profile elements each have sipes and the profile elements of the one group of profile elements are provided with sipes having a relatively greater width than the sipes of the other group of the profile elements.

### BACKGROUND OF THE INVENTION

The present invention relates to a tire having a tread band with a tread profile comprised, for example, of profiled elements such as, for example, profiled blocks or lugs which are arranged in pitches of differing lengths and have sipes or small grooves.

It is conventional to reduce or to positively influence the rolling noise of tires by configuring their tread bands such that their tread profiles are comprised of similarly configured profile elements extending in a following arrangement one after the other around the tire circumference—referred to as pitches—and having differing circumferential lengths. Pitches of greater circumferential lengths are typically comprised of those profile elements having a relatively larger circumferential length. In general, the profile elements are arranged in pitches having between three to five different circumferential lengths, whereby the length relationship of the pitches is predetermined before the manufacture of the tire and a favorable, one after another serial arrangement of the pitches around the tire circumference, the so-called pitch sequence, is determined by means of a computer program.

In particular in connection with passenger vehicle winter tires, it is further conventionally known to reduce the stiffness of the tread band by the use of sipes. In order to make as uniform as possible the stiffness of the profile elements with the smaller circumferential lengths and the stiffness of the profile elements with the larger circumferential lengths, it is also conventionally known to provide fewer sipes in the shorter profile elements as compared to the longer profile elements. A tire with a tread band configured in this manner is disclosed, for example, in AT-B 404 341. A uniformly distributed tread profile stiffness should be provided, if not over the entire tire profile circumference, at least within a predetermined profile region extending in the circumferential direction in order to ensure the greatest possible uniform wear of the tread band.

### SUMMARY OF THE INVENTION

The present invention offers a solution to the challenge of providing a further and/or additional, easily realizable possibility to influence the stiffness of the profile elements in the tread band of a tire, in order to achieve, in a targeted manner, a reduction of the stiffness of the tire.

In accordance with the present invention, a solution is provided in that the profile elements having the relatively larger circumferential lengths are provided with sipes having a relatively larger width than those profile elements having a relatively smaller circumferential length. In accordance with the present invention, the desired stiffness reduction of the profile elements can be very precisely targeted through the application of the sipes and, in a simplified manner, a variation of the width of the sipes can be employed to influence the stiffness reduction of the tire. In this manner, the present invention makes available to a tire manufacturer a further measure for accommodating or specifying the scope of the stiffness reduction of a tread band.

In accordance with the present invention, the number of sipes in a profile element of relatively greater circumferential length can be in agreement with the number of sipes in a profile element of relatively smaller circumferential length or, alternatively, the number of sipes in a profile element of relatively greater circumferential length can be greater than the number of sipes in a profile element of relatively smaller circumferential length. In accordance with the structure of the profile of the tread band and in accordance with the given relationships between the circumferential lengths of the profile elements, one or more of the stiffness reduction measures of the present invention can be advantageous.

In accordance with the present invention, a profile element can have a combination of relatively wider sipes and relatively less wide sipes. Additionally, this measure permits a targeted influence to be exerted on the stiffness or, respectively, the reduction in stiffness, of a profile element and is particularly implemented in correspondence with the path of the sipes in a profile element.

The invention is described in more detail hereafter in connection with the figures of the drawing which schematically show two embodiments of the tread band of the present invention.

### BRIEF DESCRIPTION OF THE DRAWINGS

The object and advantages of the present invention will appear more clearly from the following specification in conjunction with the accompanying drawings, in which:

FIG. 1 is a top plan schematic view of a flattened circumferential portion of a tread band of a tire having a first basic embodiment of the present invention; and

FIG. 2 is a top plan schematic view of a flattened circumferential portion of a tread band of a tire having a second basic embodiment of the present invention.

### DETAILED DESCRIPTION OF THE PREFERRED EMBODIMENTS

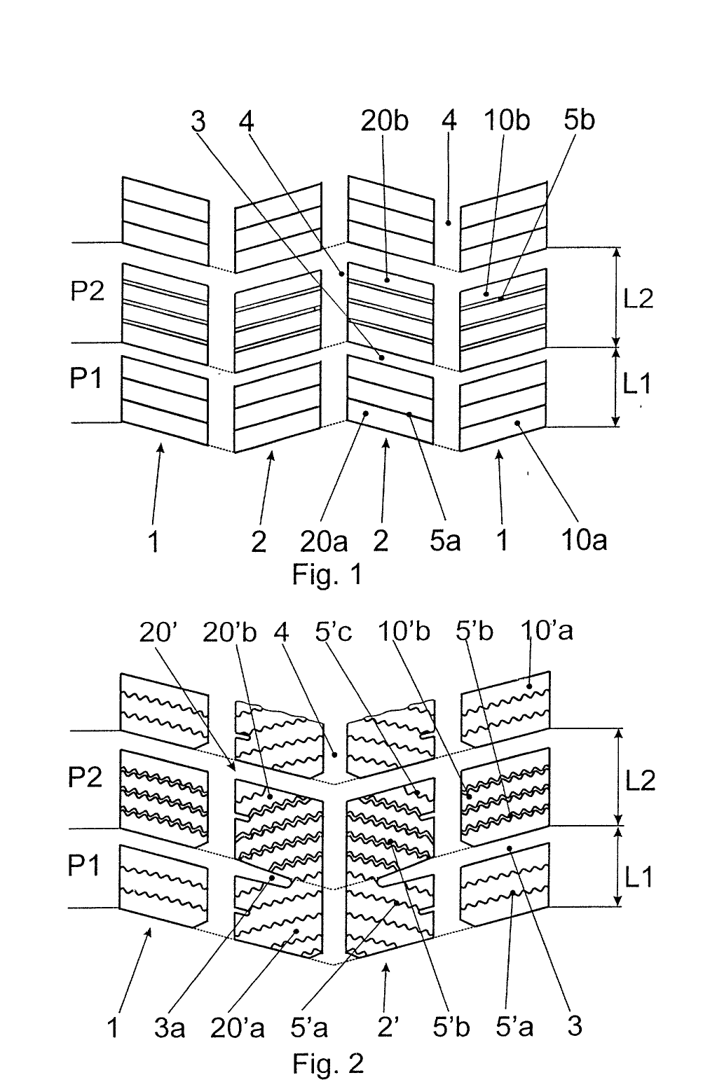

The present invention relates to a special configuration of the sipes or small grooves in the profile elements of a tread band of a tire which are configured as a function of the circumferential length of the profile elements or, respectively, in correspondence with the pitch lengths. In this connection, as a preliminary matter, the description of the present invention makes reference to the terms “pitch,”“length of a pitch,” and “pitch sequence” depicted in the figures of the drawing. The term “pitch” is to be understood as a section or cross-section of a tread profile, whereby the tread profile is formed by a one after another serial arrangement of a plurality of pitches around the circumference of the tread band. A tread band has blocks arranged in circumferentially extending rows and each pitch is comprised of a respective block of each of the rows of blocks, as viewed transversely across the tread band perpendicular to the circumference, and one of the transverse grooves which borders on these so configured blocks. Conventionally, the collective tread profile sections or, respectively, pitches, which together comprise the tread band, are at least substantially uniformly configured but are, however, arranged in differing circumferential lengths. A tread band for a passenger vehicle tire is, in general, comprised of two to five pitches of differing lengths. The one after another following arrangement of the pitches around the tire circumference—namely, the pitch sequence—is responsible for the type of tire/roadway noise which arises and is typically calculated by means of a computer. The embodiments of a tread band of a tire shown in FIGS. 1 and 2 of the drawings show, respectively, pitches P1, P2 having respective different lengths L1 and L2, whereby L1<L2.

The sipes or small grooves within the scope of the present invention can be arranged as desired along the circumferential or transverse direction of the tread band. They can follow any desired path such as, for example, a straight line path, a wave shaped path, or a zigzag shaped path and, within the profile elements in which they extend, the sipes can be communicated on one end thereof, on both ends thereof, or on neither end thereof with the grooves or other structures bordering the profile elements.

As seen in FIG. 1, one embodiment of the tread band of the present invention includes a tread profile in which four block rows 1, 2 are arranged such that there is a respective pair of shoulder block rows 1 and two block rows 2 therebetween forming the middle region of the tread band. The demarcation or separation of the blocks of the block rows 1, 2 is achieved by three circumferential grooves 4 and a plurality of transverse grooves 3. The pitch P1 illustrated in FIG. 1 comprises in each case a block 10a, 20a of each respective block row 1, 2; the pitch P2 in each case comprises a block 10b, 20b of each respective block row. Each pitch P1, P2 further comprises a transverse groove 3 that communicates with the circumferential groove. The border or limit of each pitch extends along the block edges comprised in the pitch and their imaginary extensions which, as shown by the broken lines in FIG. 1, cross the circumferential grooves 4. The difference between the circumferential lengths L1 and L2 of the pitches P1, P2 results, at a minimum, from the differing circumferential length of the blocks 10a, 10b, 20a, 20b, provided in the pitches P1, P2, so that in pitch P2 the length L2 of the respective block 10b, 20b is, in any event, longer. In pitch P2 with the relatively longer circumferential length L2, the width of the respective transverse groove 3 is also somewhat larger. This is, however, a design choice and can be differently configured or dimensioned.

The blocks 10a, 20a belonging to the pitch P1 having the relatively shorter circumferential length L1 each comprise two sipes or small grooves 5a which, in the embodiment of the tread band shown in FIG. 1, extend across the blocks parallel to those edges of the blocks 10a, 20a that are bordered by the transverse grooves 3. The respective blocks 10a, 20b of the pitch P2 having the relatively longer circumferential length L2 each comprise three sipes or small grooves 5b extending parallel to the block edges which are bordered by the transverse grooves 3. In this connection, the sipes 5a in the blocks 10a, 20a within the pitches P1 have a width which is less than the width of the sipes 5b in the blocks 10b, 20b of the pitches P2. The width of the smaller sipes 5a is approximately 0.5 mm; the width of the wider sipes 5b is approximately 0.8 mm. These widths can be varied in a given region; for the smaller sipes 5a, the width can in particular be dimensioned between 0.4 and 0.6 mm; for the relatively wider sipes 5b, the width can in particular be dimensioned between 0.7 and 1 mm.

FIG. 2 shows another embodiment of a tread band of the present invention which includes as well two shoulder block rows 1 and two middle block rows 2′ in which, respectively, block portions 20′a, 20′b are serially arranged relative to one another in the circumferential direction and are connected to one another to form a double block 20′. In this connection, only every other transverse groove 3 extends to the middle circumferential groove 4; the other transverse grooves 3 are truncated grooves 3a, which end within the double block 20′. The shoulder blocks 10′b of the pitch P2 having the relatively longer circumferential length L2 are each provided with three wave-shaped sipes 5′b; the blocks 10′a in the pitches P1 having the relatively shorter circumferential length L1 are provided with two sipes 5′a. Also in this embodiment of the tread band of the present invention, the sipes 5′a in the shoulder blocks 10′a are smaller than the sipes 5′b in the longer blocks 10′b.

The double blocks 20′ have, as is also shown by the depicted pitch borders, their respective block portions 20′b in a pitch P2 with relatively larger circumferential length L2 and have their other respective block portions 10′a in a pitch P1 with its relatively smaller circumferential length. The double block 20′ is provided with wave-shaped sipes 5′a, 5′b, and 5′c, whose longitudinal orientation is chosen such that these sipes extend in an opposite sense or orientation to the transverse grooves 3 or, respectively, to the truncated grooves 3a. In this manner, the number of oppositely sensed sipes all having the same spacing from one another can be chosen as a number which is larger in comparison to the number of sipes which would otherwise extend parallel to the transverse grooves 3, or, respectively, to the truncated grooves 3a. The block portion 20′a, which belongs to a pitch P1 having a relatively smaller circumferential length, has five wave-shaped sipes 5′a, all of which are narrow. The block portion 20′b, which belongs to a pitch P2 of relatively greater circumferential length, includes six wave-shaped sipes 5′b, 5′c, of which the four middle sipes 5′b thereof are the wider sipes. The two outer sipes 5′c, in the same manner as the sipes 5′a in the other block portion 20′a, are narrow. This stiffness reduction measure can be favorable in order to avoid too large a stiffness reduction of the tread profile elements or blocks which would otherwise arise by the provision of the sipes in the somewhat smaller block regions.

In accordance with a further embodiment of the present invention, which is not illustrated in the figures of the drawing, the number of sipes in a profile element which belongs to a pitch having a relatively larger circumferential length can be in agreement with the number of sipes in a profile element which belongs to a pitch having a relatively smaller circumferential length, whereby, preferably, the collective sipes in those blocks or, respectively, in those profile elements having a greater circumferential length, are wider than the sipes in the profile elements or, respectively, in the blocks, having the relatively smaller circumferential length. This stiffness reduction approach is especially favorable if the length difference between the profile elements is not very large.

Thus, in accordance with the present invention, the stiffness of the profile elements can be influenced, especially by means of an additional tread configuration measure or as a tread configuration measure in lieu of the conventional accommodation of the number of sipes to the respective pitch length or, respectively, to the circumferential length of the profile element. The present invention thus provides the further possibility to influence the ductility of the profile elements under pressure. The different stiffnesses or ductility of the tread band, which are specified by the pitch length variations of the larger and smaller profile elements, can be achieved in an improved and more targeted manner than is possible with the approach in which a variation of the number of sipes is undertaken.

The present invention is implementable with particular advantage in connection with the construction of tread bands for passenger vehicle winter tires, which conventionally are provided with a plurality of sipes.

The present invention is not limited to the embodiments herein described. In accordance with the present invention, tread bands formed in accordance with the present invention can also include profile elements or tread band strips extending circumferentially which may be structured, for example, with truncated grooves. The sipes in a profile element can have various depths and/or different counter-set distances and/or differing widths.

The specification incorporates by reference the disclosure of German priority document 100 32 372.3 of Jul. 6, 2000.

The present invention is, of course, in no way restricted to the specific disclosure of the specification and drawings, but also encompasses any modifications within the scope of the appended claims.

What we claim is: A vehicle tire comprising:

1. A tread band formed of profile elements including a selected one of at least one profiled block and no profiled blocks, one group of the profile elements having relatively greater circumferential lengths than another group of profile elements and the one group and the other group of the profile element each being arranged in respective pitches, the one group of the profile elements and the other group of profile elements each having sipes, and the profile elements of the one group of profile elements being provided with sipes having a relatively greater width than the sipes of the other group of the profile elements.

2. A vehicle tire according to claim 1, wherein the number of sipes in a given profile element of the one group of profile elements is in agreement with the number of sipes in a profile element of the other group of profile elements.

3. A vehicle tire according to claim 1, wherein the number of sipes in a given profile element of the one group of profile elements is greater than the number of sipes in a profile element of the other group of profile elements.

4. A vehicle tire according to claim 1, wherein, within a given profile element of the one group of profile elements, a combination of the relatively wider sipes and the relatively smaller width sipes is provided.
